(19) United States
(12) Patent Application Publication
(10) Pub. No.: US 2016/0372065 A1
(43) Pub. Date: Dec. 22, 2016

(54) DRIVING CONTROLLING METHOD OF LIQUID CRYSTAL PANEL PIXELS AND LIQUID CRYSTAL PANELS

(71) Applicants: SHENZHEN CHINA STAR OPTOELECTRONICS TECHNOLOGY CO., LTD., Shenzhen City, Guangdong (CN); WUHAN CHINA STAR OPTOELECTRONICS TECHNOLOGY CO., LTD., Wuhan, Hubei (CN)

(72) Inventors: Qingcheng ZUO, Shenzhen, Guangdong (CN); Feilin JI, Shenzhen, Guangdong (CN)

(73) Assignee: Shenzhen China Star Optoelectronics Technology Co., Ltd., Shenzhen, Guangdong (CN)

(21) Appl. No.: 14/646,016

(22) PCT Filed: Feb. 28, 2015
(86) PCT No.: PCT/CN2015/073408

§ 371 Date: May 19, 2015

(30) Foreign Application Priority Data
Feb. 11, 2015 (CN) 2001510072515.7

(51) Int. Cl. G09G 3/36; G02F 1/1368; G02F 1/1343; G02F 1/1335; G02F 1/1362

(52) U.S. Cl. CPC G09G 3/3648; G02F 1/133514; G02F 1/136286; G02F 1/134336; G02F 1/1368; G09G 2310/0251; G09G 2330/021

(57) ABSTRACT

A driving controlling method of liquid crystal panel pixels and a liquid crystal panel are disclosed. The method includes: a charging period being configured for switching one frame of the liquid crystal panel, and at least one charging period comprises a high-voltage charging phase and a voltage correction phase. Voltage amplitude within the high-voltage charging phase is larger than a predetermined voltage amplitude such that the liquid crystal panel pixels accumulate an amount of electricity within a shorter time period. The voltage amplitude within the voltage correction phase equals to a default voltage such that the voltage is precisely configured to be the default voltage. In this way, the liquid crystal panel pixels may quickly reach a default voltage so as to enhance the display performance of the liquid crystal panel.

### BACKGROUND OF THE INVENTION

1. Field of the Invention

The present disclosure relates to liquid crystal display technology, and more particularly to a driving controlling method of liquid crystal panel pixels and a liquid crystal panel.

2. Discussion of the Related Art

With the development of liquid crystal device (LCD), consumer's demand toward high resolution and large-scale panels have been increased recently.

Conventional liquid crystal panels usually include an array substrate and an opposite color film substrate. The array substrate includes one set of data lines extending along a first direction and one set of gate line extending along a second direction. The data lines and the gate lines defines a plurality of pixel cells arranged in a matrix. Each of the pixel cells includes one thin film transistor (TFT). The color film substrate includes color filters. The liquid crystal panel controls the charging time of the data lines via driving the TFTs on the liquid crystal panel by a gate driving circuit. By incorporating the voltage on the data line, the pixels are charged and discharged so as to display images. Currently, the timing diagram of the driving method are shown as FIG. 1.

In step S1, when GATE_(N) is within the high level period, i.e., the GATE_(N) is within the turn-on period (T) of one frame, and the TFTs are turned on, the pixels of the liquid crystal panel are charged via the SOURCE_(N).

In step S2, which is the first phase (the first frame after the image has been switched), when GATE_(N) is within the high level period and the TFTs are turned on, the SOURCE_(N) provides the voltage (−V₁) to charge the pixel capacitors, which include the CLD and CST capacitors. After the time period (T), the pixel capacitors are charged and the pixel voltage reaches the charging voltage (−V₁) of the SOURCE_(N).

In step S3 (phase N), when the GATE_(N) is within the high level period and the TFTs are turned on, the SOURCE_(N) provides the voltage (+V_{N}) to charge the pixel capacitors, which include the CLD and CST capacitors. After the time period (T), the pixel capacitors are charged and the pixel voltage reaches the charging voltage (+V_{N}) of the SOURCE_(N).

In step S4 (phase N+1), when the GATE_(N) is within the high level period and the TFTs are turned on, the SOURCE_(N) provides the voltage (−V_{N+1}) to charge the pixel capacitors, which include the CLD and CST capacitors. After the time period (T), the pixel capacitors are charged and the pixel voltage reaches the charging voltage (−V_{N+1}) of the SOURCE_(N).

In step S5, steps S1 through S4 are repeated so as to refresh the images.

In order to satisfy the increasing demand for high resolution, in one aspect, a large amount of data lines (SOURCE) and gate lines (GATE) are configured such that the charging time period of each pixel has been shortened. In another aspect, the length of the data lines and the gate lines is also increased due to the increment of panel dimension. As the loading for the data lines and the gate driving circuit is huge, the voltage signals of the data lines and the gate driving circuit are faded greatly. Thus, the voltage is insufficient for charging each of the pixels, which deteriorates the display performance.

### SUMMARY

According to the present disclosure, the driving controlling method of liquid crystal panel pixels and the liquid crystal panel may contribute to the undercharge issue of the liquid crystal pixels resulting from short time period and huge loading loss.

In one aspect, a driving controlling method of liquid crystal panel pixels includes: a charging period being configured for switching one frame of the liquid crystal panel, at least one charging period includes a high-voltage charging phase and a voltage correction phase; a voltage amplitude within the high-voltage charging phase is larger than a predetermined voltage amplitude such that the liquid crystal panel pixels accumulate an amount of electricity within a shorter time period; the voltage amplitude within the voltage correction phase equals to a default voltage such that the voltage is precisely configured to be the default voltage; when a plurality of charging periods includes the high-voltage charging phase and the voltage correction phase, the voltage amplitude during each of the high-voltage charging phase equals to several times of the default voltage amplitude, or during at least two charging periods, the voltage amplitude of the high-voltage charging phase have been magnified by different times with respect to the default voltage amplitude; and the charging period of each of the high-voltage charging phase are the same, or the voltage amplitude of at least high-voltage charging phases are different; and the high-voltage charging phase includes a plurality of high-voltage charging sub-phases, and the voltage amplitude of at least two high-voltage charging sub-phase are different.

Wherein the voltage amplitude of the high-voltage charging sub-phases are configured to be descending progressively.

Wherein the voltage amplitude of the high-voltage charging sub-phases are configured to be increased progressively and then be decreased progressively.

In another aspect, a driving controlling method of liquid crystal panel pixels includes: a charging period being configured for switching one frame of the liquid crystal panel, at least one charging period includes a high-voltage charging phase and a voltage correction phase; a voltage amplitude within the high-voltage charging phase is larger than a predetermined voltage amplitude such that the liquid crystal panel pixels accumulate an amount of electricity within a shorter time period; and the voltage amplitude within the voltage correction phase equals to a default voltage such that the voltage is precisely configured to be the default voltage.

Wherein when a plurality of charging periods includes the high-voltage charging phase and the voltage correction phase, the voltage amplitude during each of the high-voltage charging phase equals to several times of the default voltage amplitude

Wherein when a plurality of charging periods includes the high-voltage charging phase and the voltage correction phase, during at least two charging periods, the voltage amplitude of the high-voltage charging phase have been magnified by different times with respect to the default voltage amplitude.

Wherein when a plurality of charging periods includes the high-voltage charging phase and the voltage correction phase, the charging period of each of the high-voltage charging phase are the same.

Wherein when the charging period of each of the high-voltage charging phase are the same, the voltage amplitude of at least high-voltage charging phases are different.

Wherein when the high-voltage charging phase includes a plurality of high-voltage charging sub-phases, and the voltage amplitude of at least two high-voltage charging sub-phase are different.

Wherein the voltage amplitude of the high-voltage charging sub-phases are configured to be descending progressively.

Wherein the voltage amplitude of the high-voltage charging sub-phases are configured to be increased progressively and then be decreased progressively.

Wherein when a source driving circuit is within a high level period and thin film transistors (TFTs) are turned on, the liquid crystal panel pixels are charged via data lines to enter one charging period.

In another aspect, a liquid crystal panel includes: a liquid crystal cell, an array substrate and a color-film substrate, the array substrate and the color-film substrate are respectively arranged at two sides of the liquid crystal cell; the array substrate includes one set of data lines extending along the first direction and one set of gate lines extending along the second direction, the data lines and the gate lines cooperatively define a plurality of liquid crystal panel pixel cells arranged in a matrix form, each of the pixel cells includes one TFT, and the color-film substrate includes color filters; and the data lines are configured for charging the liquid crystal panel pixels, the charging voltage of the data lines includes a first charging voltage and a second charging voltage, the amplitude of the first charging voltage is larger than a default voltage of the liquid crystal panel pixels, and the amplitude of the second charging voltage equals to the default voltage of the liquid crystal panel pixels.

In view of the above, one charging period is divided into a high-voltage charging phase and a voltage correction phase. As the default voltage is magnified, the voltage drop caused by the energy loss may be compensated. As such, the liquid crystal pixels may quickly accumulate an amount of electricity within a shorter time period. Afterward, the voltage is corrected by the default voltage such that the voltage may be precisely configured to be the default voltage. Thus, the charging issues of the liquid crystal pixels caused by the energy loss within a shorter time period may be overcome. Also, the liquid crystal pixels may reach the default voltage quickly so as to enhance the display performance.

### BRIEF DESCRIPTION OF THE DRAWINGS

FIG. 1 is a flowchart illustrating the conventional driving controlling method of liquid crystal panel pixels.

FIG. 2 is a driving timing diagram of the driving controlling method of FIG. 1.

FIG. 3 is a flowchart illustrating the driving controlling method of liquid crystal panel pixels in accordance with a first embodiment.

FIG. 4 is a driving timing diagram of the driving controlling method of FIG. 3.

FIG. 5 is a flowchart illustrating the driving controlling method of liquid crystal panel pixels in accordance with a second embodiment.

FIG. 6 is a flowchart illustrating phase one of the driving controlling method of liquid crystal panel pixels in accordance with a third embodiment.

FIG. 7 is a schematic view of the liquid crystal panel in accordance with one embodiment.

FIG. 8 is a schematic view of the circuit of the array substrate of FIG. 7.

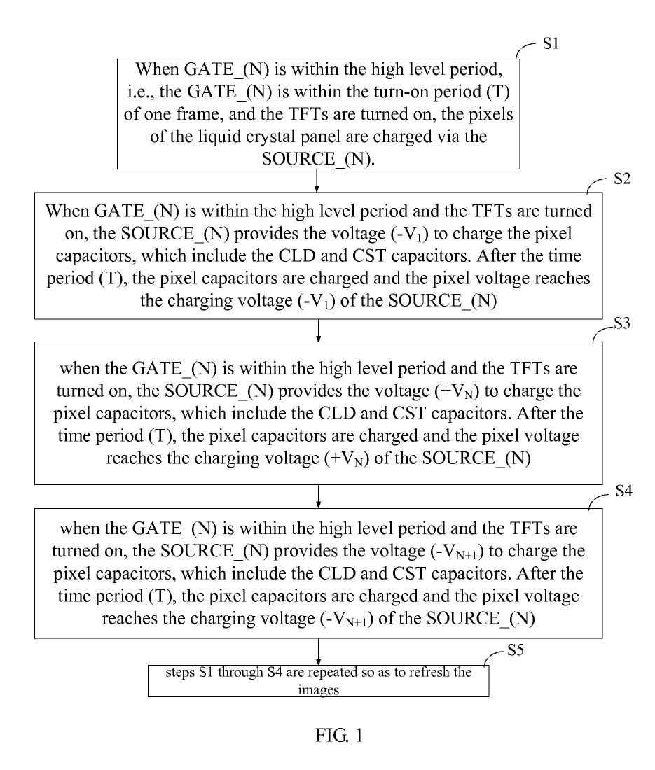

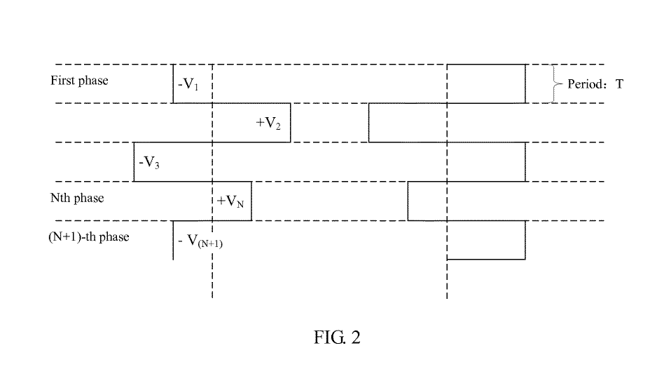

### DETAILED DESCRIPTION OF THE EMBODIMENTS

Embodiments of the invention will now be described more fully hereinafter with reference to the accompanying drawings, in which embodiments of the invention are shown.

The present disclosure relates to a driving controlling method of liquid crystal panel pixels. The time period for switching one frame is defined as a charging period. At least one of the charging period includes a high-voltage charging phase and a voltage correction phase. During the high-voltage charging phase, the voltage amplitude is larger than a default voltage such that the liquid crystal pixels may quickly accumulate an amount of electricity within a shorter time period. During the voltage correction phase, the voltage amplitude equals to the default voltage such that the voltage is precisely configured to be the default voltage.

Compared to the conventional technical solutions, the present disclosure divides one charging period to the high-voltage charging phase and the voltage correction phase. As the default voltage is magnified, the voltage drop caused by the energy loss may be compensated. As such, the liquid crystal pixels may quickly accumulate an amount of electricity within a shorter time period. Afterward, the voltage is corrected by the default voltage such that the voltage may be precisely configured to be the default voltage. Thus, the charging issues of the liquid crystal pixels caused by the energy loss within a shorter time period may be overcome. Also, the liquid crystal pixels may reach the default voltage quickly so as to enhance the display performance.

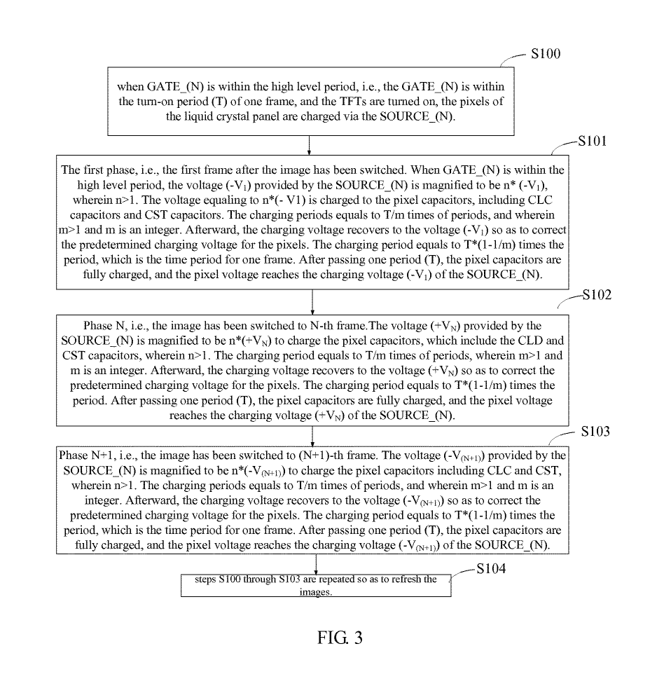

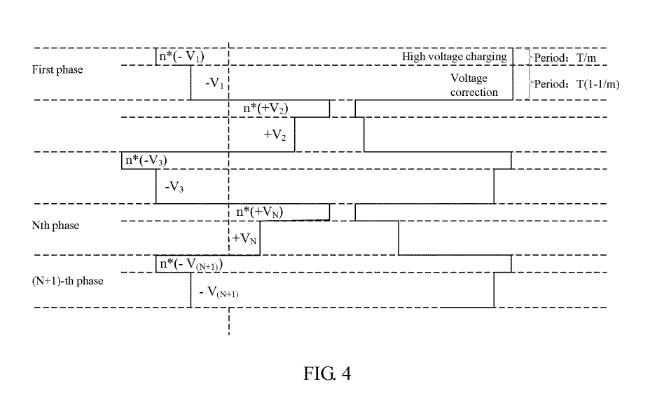

FIG. 3 is a flowchart illustrating the driving controlling method of liquid crystal panel pixels in accordance with a first embodiment. FIG. 4 is a driving timing diagram of the driving controlling method of FIG. 3.

In the embodiment, a plurality of charging periods includes the high-voltage charging phase and the voltage correction phase. The voltage amplitude during each of the high-voltage charging phase equals to several times of the default voltage amplitude. In addition, the charging period of each of the high-voltage charging phase is the same.

For instance, the liquid crystal panel may switch (N+1) frames after (N+1) charging phases, i.e., (N+1) charging periods. In the embodiment, the (N+1) charging periods include the high-voltage charging phase and the voltage correction phase, wherein T is indicative of a charging period, V₁ is indicative of the default voltage when the first frame is switched, V_{N} is indicative of the default voltage when the N-th frame is switched, and V_{(N+1)} is indicative of the default voltage when the (N+1)-th frame is switched,

Specifically, the driving controlling method includes the following steps.

In step S100, when GATE_(N) is within the high level period, i.e., the GATE_(N) is within the turn-on period (T) of one frame, and the TFTs are turned on, the pixels of the liquid crystal panel are charged via the SOURCE_(N).

In step S101, which is the first phase (the first frame after the image has been switched), when GATE_(N) is within the high level period, the voltage (−V₁) provided by the SOURCE_(N) is magnified to be n*(−V₁), wherein n>1. The voltage equaling to n*(−V₁) is charged to the pixel capacitors, including CLC capacitors and CST capacitors. The charging periods equals to T/m times of periods, and wherein m>1 and m is an integer. Afterward, the charging voltage recovers to the voltage (−V₁) so as to correct the predetermined charging voltage for the pixels. The charging period equals to T*(1−1/m) times the period, which is the time period for one frame. After passing one period (T), the pixel capacitors are fully charged, and the pixel voltage reaches the charging voltage (−V₁) of the SOURCE_(N).

In step S102 (phase N), the image has been switched to N-th frame. The voltage (+V_{N}) provided by the SOURCE_(N) is magnified to be n*(+V_{N}) to charge the pixel capacitors, which include the CLD and CST capacitors, wherein n>1. The charging period equals to T/m times of periods, wherein m>1 and m is an integer. Afterward, the charging voltage recovers to the voltage (+V_{N}) so as to correct the predetermined charging voltage for the pixels. The charging period equals to T*(1−1/m) times the period. After passing one period (T), the pixel capacitors are fully charged, and the pixel voltage reaches the charging voltage (+V_{N}) of the SOURCE_(N).

In step S103 (phase N+1), the image has been switched to (N+1)-th frame. The voltage (−V_{(N+1)}) provided by the SOURCE_(N) is magnified to be n*(−V_{(N+1)}) to charge the pixel capacitors including CLC and CST, wherein n>1. The charging periods equals to T/m times of periods, and wherein m>1 and m is an integer. Afterward, the charging voltage recovers to the voltage (−V_{(N+1)}) so as to correct the predetermined charging voltage for the pixels. The charging period equals to T*(1−1/m) times the period, which is the time period for one frame. After passing one period (T), the pixel capacitors are fully charged, and the pixel voltage reaches the charging voltage (−V_{(N+1)}) of the SOURCE_(N).

In step S104, steps S100 through S103 are repeated so as to refresh the images.

In the embodiments, n and m are equal in each phase. That is, the voltage amplitude during the high-voltage charging phase are configured to be magnified for the same times in each phase. In addition, the time period of the high-voltage charging phase in each phase are the same.

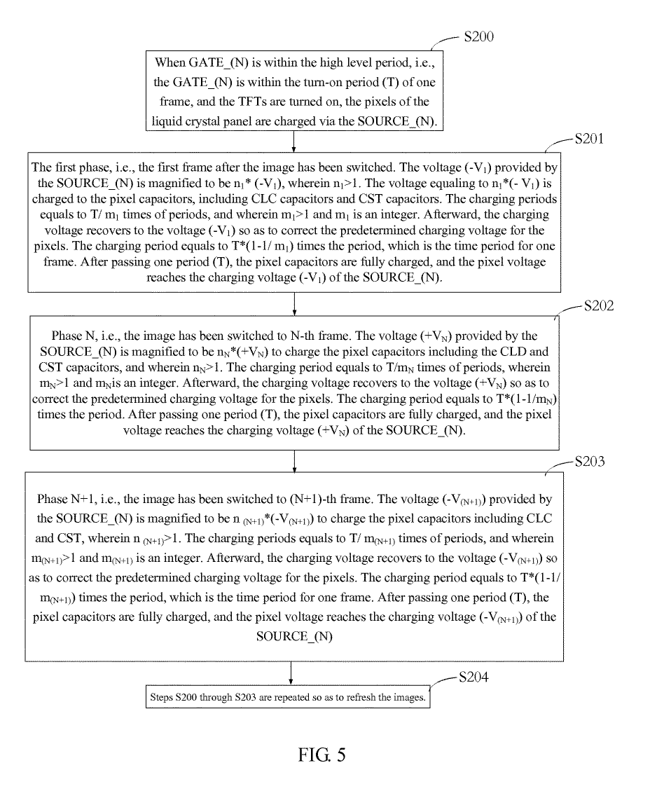

FIG. 5 is a flowchart illustrating the driving controlling method of liquid crystal panel pixels in accordance with a second embodiment.

In the embodiment, a plurality of charging period include the high-voltage charging phase and the voltage correction phase. During at least two charging period, the voltage amplitude of the high-voltage charging phase have been magnified by different times with respect to the default voltage amplitude. The charging period for at least two high-voltage charging phase are different.

For instance, the liquid crystal panel may switch (N+1) frames after (N+1) charging phases, i.e., (N+1) charging periods. In the embodiment, the (N+1) charging periods include the high-voltage charging phase and the voltage correction phase, wherein T is indicative of a charging period, V₁ is indicative of the default voltage when the first frame is switched, V_{N} is indicative of the default voltage when the N-th frame is switched, and V_{(N+1)} is indicative of the default voltage when the (N+1)-th frame is switched,

Specifically, the driving controlling method includes the following steps.

In step S200, when GATE_(N) is within the high level period, i.e., the GATE_(N) is within the turn-on period (T) of one frame, and the TFTs are turned on, the pixels of the liquid crystal panel are charged via the SOURCE_(N).

In step S201, which is the first phase (the first frame after the image has been switched), the voltage (−V₁) provided by the SOURCE_(N) is magnified to be n₁*(−V₁), wherein n₁>1. The voltage equaling to n₁*(−V₁) is charged to the pixel capacitors, including CLC capacitors and CST capacitors. The charging periods equals to T/m₁ times of periods, and wherein m₁>1 and m₁ is an integer. Afterward, the charging voltage recovers to the voltage (−V₁) so as to correct the predetermined charging voltage for the pixels. The charging period equals to T*(1−1/ m₁) times the period, which is the time period for one frame. After passing one period (T), the pixel capacitors are fully charged, and the pixel voltage reaches the charging voltage (−V₁) of the SOURCE_(N).

In step S202 (phase N), the image has been switched to N-th frame. The voltage (+V_{N}) provided by the SOURCE_(N) is magnified to be n_{N}*(+V_{N}) to charge the pixel capacitors including the CLD and CST capacitors, and wherein n_{N}>1. The charging period equals to T/m_{N} times of periods, wherein m_{N}>1 and m_{N} is an integer. Afterward, the charging voltage recovers to the voltage (+V_{N}) so as to correct the predetermined charging voltage for the pixels. The charging period equals to T*(1−1/m_{N}) times the period. After passing one period (T), the pixel capacitors are fully charged, and the pixel voltage reaches the charging voltage (+V_{N}) of the SOURCE_(N).

In step S203 (phase N+1), the image has been switched to (N+1)-th frame. The voltage (−V_{(N+1)}) provided by the SOURCE_(N) is magnified to be n_{(N+1)}*(−V_{(N+1)}) to charge the pixel capacitors including CLC and CST, wherein n_{(N+1)}>1. The charging periods equals to T/m_{(N+1)} times of periods, and wherein m_{(N+1)}>1 and m_{(N+1)} is an integer. Afterward, the charging voltage recovers to the voltage (−V_{(N+1)}) so as to correct the predetermined charging voltage for the pixels. The charging period equals to T*(1−1/ m_{(N+1)}) times the period, which is the time period for one frame. After passing one period (T), the pixel capacitors are fully charged, and the pixel voltage reaches the charging voltage (−V_{(N+1)}) of the SOURCE_(N)

In step S204, steps S200 through S203 are repeated so as to refresh the images.

In the embodiment, n₁, n_{N}, . . . , and n_{(N+1)} are different. That is, m may be adjusted in accordance with the frame. Also, m₁, m_{N}, . . . , and m_{(N+1)} are different.

In other embodiments, at least two of the n₁, n_{N}, . . ., and n_{(N+1)} are different, and m₁, m_{N}, . . . , and m_{(N+1)} are the same. Alternatively, n₁, n_{N}, . . . , and n_{(N+1)} are the same, and at least two of m₁, m_{N}, . . . , and m_{(N+1)} are different.

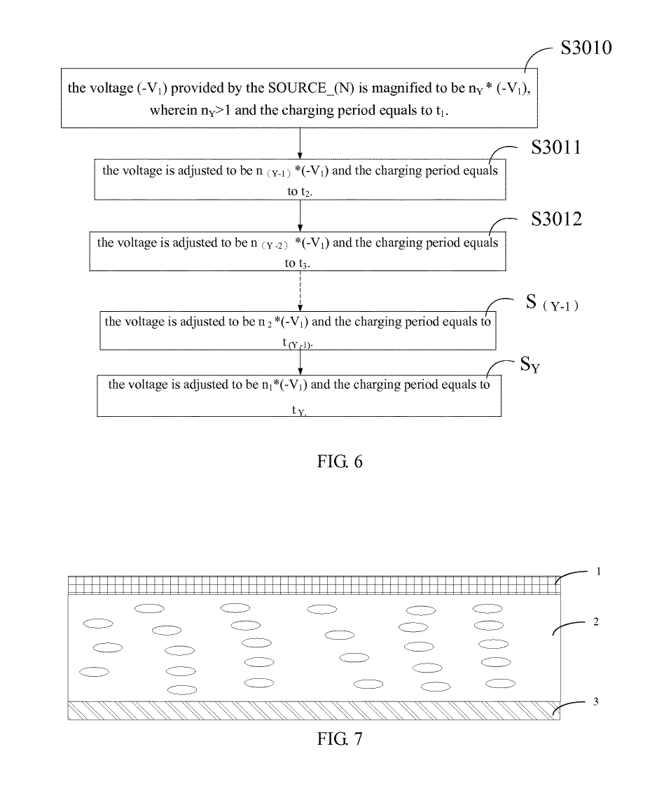

FIG. 6 is a flowchart illustrating phase one of the driving controlling method of liquid crystal panel pixels in accordance with a third embodiment.

In the embodiment, the high-voltage charging phase includes a plurality of high-voltage charging sub-phases. At least two of the high-voltage charging sub-phases have different voltage amplitude. In addition, the voltage amplitude of the high-voltage charging sub-phases are configured to be descending progressively.

For instance, a first phase includes the following steps.

In step S3010, the voltage (−V₁) provided by the SOURCE_(N) is magnified to be n_{Y}*(−V₁), wherein n_{Y}>1 and the charging period equals to t₁.

In step S3011, the voltage is adjusted to be n_{(Y-1)}*(−V₁) and the charging period equals to t₂.

In step S3012, the voltage is adjusted to be n_{(Y-2)}*(−V₁) and the charging period equals to t₃.

Similarly, in step S_{(Y-1)}, the voltage is adjusted to be n₂*(−V₁) and the charging period equals to t_{(Y-1)}. In step S_{Y}, the voltage is adjusted to be n₁*(−V₁) and the charging period equals to t_{Y}.

In the embodiment, the high-voltage charging phase in phase one may be divided to Y number of high-voltage charging sub-phases. The voltage amplitude of each high-voltage charging sub-phase are different and are configured to be descending progressively. That is, n_{Y}>n_{(Y-1)}>n_{(Y-2)}> . . . >n₂>n₁.

The sum of the charging period of the high-voltage charging sub-phase is the same with the period of the high-voltage charging phase, i.e., t₁+t₂+t₃+ . . . +t_{(Y-1)}+t_{Y}=T/m.

The voltage has been decreased from the highest voltage. In the end, the voltage is close to the default voltage so as to avoid flashing issue caused by the transition from the magnified voltage to the default voltage.

In addition, n_{Y}, n_{(Y-1)}, n_{(Y-2)}, . . . , n₂, n₁satisfy the relationship below: n_{Y}<n_{(Y-1)}<n_{(Y-2)}< . . . <n₍ₓ₊₁₎<nₓ>n₍ₓ₋₁₎> . . . >n₃>n₂>n₁. That is, the voltage amplitude of the high-voltage charging sub-phases are configured to be increased progressively and then be decreased progressively.

It can be understood that not only in phase one, the high-voltage charging phase may include a plurality of high-voltage charging sub-phases in each phase. In an example, within only one charging period, the high-voltage charging phase includes a plurality of high-voltage charging sub-phases. In addition, the number of the high-voltage charging sub-phases and the trend of the voltage amplitude may be the same or different.

FIG. 7 is a schematic view of the liquid crystal panel in accordance with one embodiment.

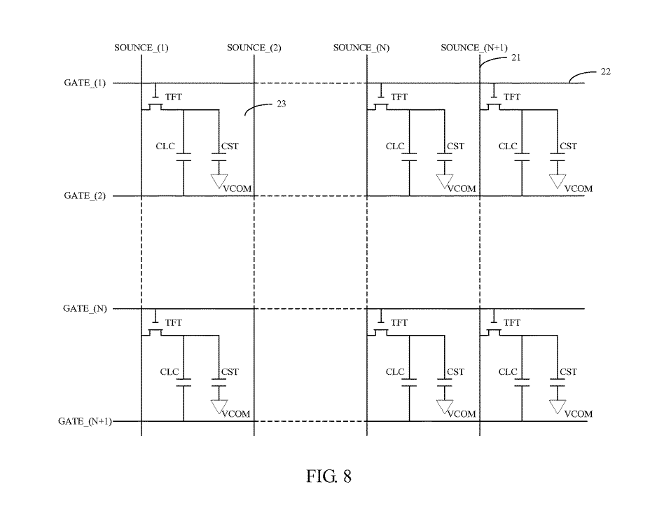

FIG. 8 is a schematic view of the circuit of the array substrate of FIG. 7.

The liquid crystal panel includes a liquid crystal cell 1, an array substrate 2, and a color-film substrate 3. The array substrate 2 and the color-film substrate 3 are respectively arranged at two sides of the liquid crystal cell 1. The array substrate 2 includes one set of data lines 21 extending along the first direction and one set of gate lines 22 extending along the second direction. The data lines 21 and the gate lines 22 define a plurality of pixel cells 23 arranged in a matrix form. Each of the pixel cells 23 includes one TFT. The color-film substrate 3 includes color filters. The data lines 21 are for charging the pixels. The charging voltage of the data lines 21 includes a first charging voltage and a second charging voltage. The amplitude of the first charging voltage is larger than a default voltage of the pixels, and the amplitude of the second charging voltage equals to the default voltage of the pixels.

In view of the above, the default voltage is magnified during the high-voltage charging phase to compensate the voltage drop caused by the energy loss. The liquid crystal pixels may quickly accumulate an amount of electricity within a shorter time period. During the voltage correction phase, the voltage amplitude equals to the default voltage such that the voltage is precisely configured to be the default voltage. In this way, the undercharge issue of the liquid crystal pixels resulting from short time period and huge loading loss may be overcome. Also, the liquid crystal pixels may reach the default voltage quickly so as to enhance the display performance.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A driving controlling method of liquid crystal panel pixels, comprising:
a charging period being configured for switching one frame of the liquid crystal panel, at least one charging period comprises a high-voltage charging phase and a voltage correction phase;
a voltage amplitude within the high-voltage charging phase is larger than a predetermined voltage amplitude such that the liquid crystal panel pixels accumulate an amount of electricity within a shorter time period;
the voltage amplitude within the voltage correction phase equals to a default voltage such that the voltage is precisely configured to be the default voltage;
when a plurality of charging periods comprises the high-voltage charging phase and the voltage correction phase, the voltage amplitude during each of the high-voltage charging phase equals to several times of the default voltage amplitude, or during at least two charging periods, the voltage amplitude of the high-voltage charging phase have been magnified by different times with respect to the default voltage amplitude; and
the charging period of each of the high-voltage charging phase are the same, or the voltage amplitude of at least high-voltage charging phases are different; and
the high-voltage charging phase comprises a plurality of high-voltage charging sub-phases, and the voltage amplitude of at least two high-voltage charging sub-phase are different.

2. The driving controlling method as claimed in claim 1, wherein the voltage amplitude of the high-voltage charging sub-phases are configured to be descending progressively.

3. The driving controlling method as claimed in claim 1, wherein the voltage amplitude of the high-voltage charging sub-phases are configured to be increased progressively and then be decreased progressively.

4. A driving controlling method of liquid crystal panel pixels, comprising:
a charging period being configured for switching one frame of the liquid crystal panel, at least one charging period comprises a high-voltage charging phase and a voltage correction phase;
a voltage amplitude within the high-voltage charging phase is larger than a predetermined voltage amplitude such that the liquid crystal panel pixels accumulate an amount of electricity within a shorter time period; and
the voltage amplitude within the voltage correction phase equals to a default voltage such that the voltage is precisely configured to be the default voltage.

5. The driving controlling method as claimed in claim 4, wherein when a plurality of charging periods comprises the high-voltage charging phase and the voltage correction phase, the voltage amplitude during each of the high-voltage charging phase equals to several times of the default voltage amplitude

6. The driving controlling method as claimed in claim 4, wherein when a plurality of charging periods comprises the high-voltage charging phase and the voltage correction phase, during at least two charging periods, the voltage amplitude of the high-voltage charging phase have been magnified by different times with respect to the default voltage amplitude.

7. The driving controlling method as claimed in claim 4, wherein when a plurality of charging periods comprises the high-voltage charging phase and the voltage correction phase, the charging period of each of the high-voltage charging phase are the same.

8. The driving controlling method as claimed in claim 4, wherein when the charging period of each of the high-voltage charging phase are the same, the voltage amplitude of at least high-voltage charging phases are different.

9. The driving controlling method as claimed in claim 4, wherein when the high-voltage charging phase comprises a plurality of high-voltage charging sub-phases, and the voltage amplitude of at least two high-voltage charging sub-phase are different.

10. The driving controlling method as claimed in claim 9, wherein the voltage amplitude of the high-voltage charging sub-phases are configured to be descending progressively.

11. The driving controlling method as claimed in claim 9, wherein the voltage amplitude of the high-voltage charging sub-phases are configured to be increased progressively and then be decreased progressively.

12. The driving controlling method as claimed in claim 4, wherein when a source driving circuit is within a high level period and thin film transistors (TFTs) are turned on, the liquid crystal panel pixels are charged via data lines to enter one charging period.

13. A liquid crystal panel, comprising:
a liquid crystal cell, an array substrate and a color-film substrate, the array substrate and the color-film substrate are respectively arranged at two sides of the liquid crystal cell;
the array substrate comprises one set of data lines extending along the first direction and one set of gate lines extending along the second direction, the data lines and the gate lines cooperatively define a plurality of liquid crystal panel pixel cells arranged in a matrix form, each of the pixel cells includes one TFT, and the color-film substrate comprises color filters; and
the data lines are configured for charging the liquid crystal panel pixels, the charging voltage of the data lines comprises a first charging voltage and a second charging voltage, the amplitude of the first charging voltage is larger than a default voltage of the liquid crystal panel pixels, and the amplitude of the second charging voltage equals to the default voltage of the liquid crystal panel pixels.
